(19) United States
(12) Patent Application Publication
(10) Pub. No.: US 2004/0143664 A1
(43) Pub. Date: Jul. 22, 2004

(54) Method for allocating computer resource

(76) Inventors: Haruhiko Usa, Ebina (JP); Tomohito Uchida, Yokohama (JP)

Correspondence Address: MCDERMOTT, WILL & EMERY, 600 13th Street, N.W., Washington, DC, 20005-3096, US

(21) Appl. No.: 10/697,648

(22) Filed: Oct. 31, 2003

(30) Foreign Application Priority Data
Dec. 20, 2002 (JP) 2002-369610

(51) Int. Cl. G06F 15/173

(52) U.S. Cl. 709/226

(57) ABSTRACT

In accordance with a policy to dynamically reallocate a computer resource to a plurality of virtual machine LPARs (Logical Partitions), optimum quantities of resource allocation are determined so that the virtual machine LPARs will hardly have resource shortages in the near future. A resource management server collects states of resource utilizations of the virtual machine LPARs and, then, forecasts next states of resource utilizations of the virtual machine LPARs on the basis of the collected states of resource utilizations. Subsequently, the resource management server computes coefficients of correlation among the virtual machine LPARs with respect to the resource utilizations of the virtual machine LPARs on the basis of execution histories of the virtual machine LPARs. Finally, the resource management server computes the optimum quantities of resource allocation on the basis of the forecasted states of resource utilizations and the computed coefficients of correlation, allocating the computer resource to the virtual machine LPARs in accordance with the computed optimum quantities of resource allocation.

### BACKGROUND OF THE INVENTION

In general, the present invention relates to a method for allocating computer resources. More particularly, the present invention relates to a computer-resource allocation method for allocating computer resources to a plurality of virtual machines on the basis of coefficients of correlation among the virtual machines so as to optimize the allocation of the computer resources in a process to dynamically allocate the computer resources to the virtual machines.

In a virtual machine system, a hypervisor logically divides and allocates computer resources owned by a physical machine to a plurality of virtual machine LPARs (Logical Partitions). Examples of computer resources owned by a physical machine are a CPU (instruction processor), a memory (a main storage unit) and a channel. A virtual machine LPAR is a virtual machine to which computer resources of actually existing physical machines are logically allocated.

A virtual machine system is introduced in documents such as U.S. Pat. No. 4,564,903. To be more specific, the virtual machine system is described in a paragraph entitled “Art Prior to the Invention” in this document. In addition, Japanese Patent Laid-open No. 6-348584 discloses a method to dynamically change the configuration of a memory allocated to a virtual machine system.

### SUMMARY OF THE INVENTION

A virtual machine system is a system capable of executing a plurality of operating systems (OS) on the hardware of a single computer. A virtual machine system is a system very useful in many applications. In a virtual machine system, it is desirable to allocate a computer resource to a plurality of virtual machine LPARs (Logical Partitions) in such a way that, the heavier the load borne by a virtual machine LPAR, the larger the quantity of the computer resource allocated to the virtual machine LPAR. In order to allocate a computer resource to a plurality of virtual machine LPARs in this way, it is necessary to provide the virtual machine system with a function for dynamically changing the quantities of the computer resource allocated to the virtual machine LPARs.

In the conventional virtual machine system, a computer resource is traditionally allocated to a virtual machine LPAR on the basis of changes in load borne by this virtual machine LPAR. However, this traditional allocation of a computer resource cannot be applied to a compound system in which a virtual machine LPAR carries out an operation correlated with other virtual machine LPARs. That is to say, with this traditional resource allocation, a computer resource cannot be allocated to a virtual machine LPAR on the basis of changes in loads borne by other virtual machine LPARs. In consequence, if the quantity of a computer resource allocated to a virtual machine LPAR is changed, it is feared that another virtual machine LPAR will most likely display an insufficient performance due to a shortage of an allocated resource in the near future. With traditional resource allocation, however, it is difficult to allocate a computer resource to a specific virtual machine LPAR by taking other virtual machine LPARs into consideration so that no other virtual machine LPAR will display an insufficient performance even if a computer resource allocated to the specific virtual machine LPAR is changed.

For example, assume a conventional virtual machine system for carrying out different jobs by using a web server, a database server and a development-use test server, which are each connected to the Internet as a server implemented by a virtual machine LPAR of the virtual machine system. In this case, there is observed a correlation between the web server and the database server wherein, when a load borne by the web server increases, a load borne by the database server will also rise as well in the near future. Nevertheless, the conventional virtual machine system is not equipped with a mechanism for reallocating a quantity of a computer resource to the web server at a point of time the load borne by the web server increases by assuming that the load borne by the database server will also rise as well in the near future. As a result, it is necessary to reallocate a quantity of the computer resource to the database server at a point of time the performance of the database server becomes insufficient.

It is thus an object of the present invention addressing the problems described above to provide a computer-resource allocation method for dynamically reallocating a computer resource to a plurality of virtual machines whereby optimum quantities of resource allocation to the virtual machines are determined on the basis of coefficients of correlation among the virtual machines and the optimum quantities of the computer resource are apportioned to the virtual machines so that the virtual machines will each hardly have a resource shortage in the near future.

In order to achieve the object described above, the computer-resource allocation method provided by the present invention to dynamically reallocate a computer resource to a plurality of virtual machine LPARs is implemented by execution of the following procedure. A resource management server collects states of resource utilizations of the virtual machine LPARs and, then, forecasts next states of resource utilizations of the virtual machine LPARs on the basis of the collected states of resource utilizations. Subsequently, the resource management server computes coefficients of correlation among the virtual machine LPARs with respect to the resource utilizations of the virtual machine LPARs on the basis of execution histories of the virtual machine LPARs. Finally, the resource management server computes the optimum quantities of resource allocation on the basis of the forecasted states of resource utilizations and the computed coefficients of correlation, allocating the computer resource to the virtual machine LPARs in accordance with the computed optimum quantities of resource allocation.

At that time, if a specific virtual machine LPAR is predicted to be going to have a shortage of an allocated computer resource, a reduction quantity is subtracted from a resource quantity apportioned to another virtual machine LPAR having a small coefficient of correlation with the specific virtual machine LPAR to be transferred to the specific virtual machine LPAR taking the precedence of the other virtual machine LPAR and, in addition, an effort is made as much as possible not to subtract a reduction quantity from a resource quantity apportioned to a further virtual machine LPAR having a large coefficient of correlation with the specific virtual machine LPAR to be transferred to the specific virtual machine LPAR. A virtual machine LPAR having a large coefficient of correlation with the specific virtual machine LPAR is defined as a virtual machine LPAR prone to a lack of performance in the near future following the shortage of a computer resource allocated to the specific virtual machine LPAR.

This is because, in the case of 2 virtual machine LPARs having a large coefficient of correlation with each other, if the quantity of a computer resource used by one of the virtual machine LPARs increases, the quantity of the same computer resource used by the other virtual machine LPAR also shows a tendency to increase as well at the same time or in the near future. That is to say, an effort needs to be made as much as possible not to subtract a reduction quantity from a resource quantity apportioned to the other virtual machine LPAR having a large coefficient of correlation with the specific virtual machine LPAR to be transferred to the specific virtual machine LPAR because, if the specific virtual machine LPAR is predicted to be going to have a shortage of an allocated computer resource, the other virtual machine LPAR also shows a tendency to be also prone to an insufficient performance as well in the near future.

By carrying out the processing described above, quantities of the computer resource allocated to virtual machine LPARs can be changed to reallocate the computer resource so that the virtual machine LPARs will each hardly have a shortage of an allocated computer resource in the near future. To put it in detail, in the processing described above in a system including a resource management server for managing resource quantities apportioned to virtual machine LPARS, if a specific virtual machine LPAR is predicted to be going to have a shortage of an allocated computer resource, reduction quantities are subtracted from a CPU allocation ratio and allocated memory area size of each other virtual machine LPAR having a small coefficient of correlation with the specific virtual machine LPAR on the basis of coefficients of correlation between the specific virtual machine LPAR and the other virtual machine LPARs, and transferred to the specific virtual machine LPAR taking the precedence of the other virtual machine LPAR. In this way, the CPU and the memory can be reallocated with a high degree of efficiency to the virtual machine LPARs.

It is also possible to provide a system for allocating computer resources pertaining to a plurality of physical machines to a plurality of virtual machine LPARs. In such a system, the computer resources allocated to any one of the virtual machine LPARs may pertain to more than one of the physical machines. In a system allowing computer resources pertaining to more than one physical machine to be allocated to any one of virtual machine LPARs, the computer resources can be reallocated with a high degree of efficiency to the virtual machine LPARs by decreasing and increasing the quantities of the allocated computer resources pertaining to several physical machines without causing the quantities to exceed limits set in advance even if the computer resources of all the physical machines have a predetermined total upper limit of allocation.

### BRIEF DESCRIPTION OF THE DRAWINGS

FIG. 1 is a diagram showing the configuration of a virtual machine system adopting a computer-resource allocation method provided by the present invention;

FIG. 2 is a diagram showing the structure of a resource utilization state table 107;

FIG. 3 is a diagram showing the structure of a correlation coefficient table 108;

FIG. 4 is a diagram showing the structure of a resource utilization forecast table 109;

FIG. 5 is a diagram showing the structure of a resource-allocation-setting table 110;

FIG. 6 is a diagram showing the structure of a resource allocation information table 111;

FIG. 7 shows a general flowchart showing execution of processes according to the computer-resource allocation method provided by the present invention;

FIG. 8 shows a flowchart representing a process to gather information on resource utilization states;

FIG. 9 shows a flowchart representing a process to find coefficients of correlation;

FIG. 10 shows a flowchart representing a process to forecast resource utilizations;

FIG. 11 shows a flowchart representing a process to determine resource allocations;

FIG. 12 shows a flowchart representing a process to determine allocated resource quantities;

FIG. 13 shows a flowchart representing a process to measure resource utilizations; and

FIG. 14 is a diagram showing the configuration of another virtual machine system adopting a computer-resource allocation method provided by the present invention.

### DESCRIPTION OF THE PREFERRED EMBODIMENTS

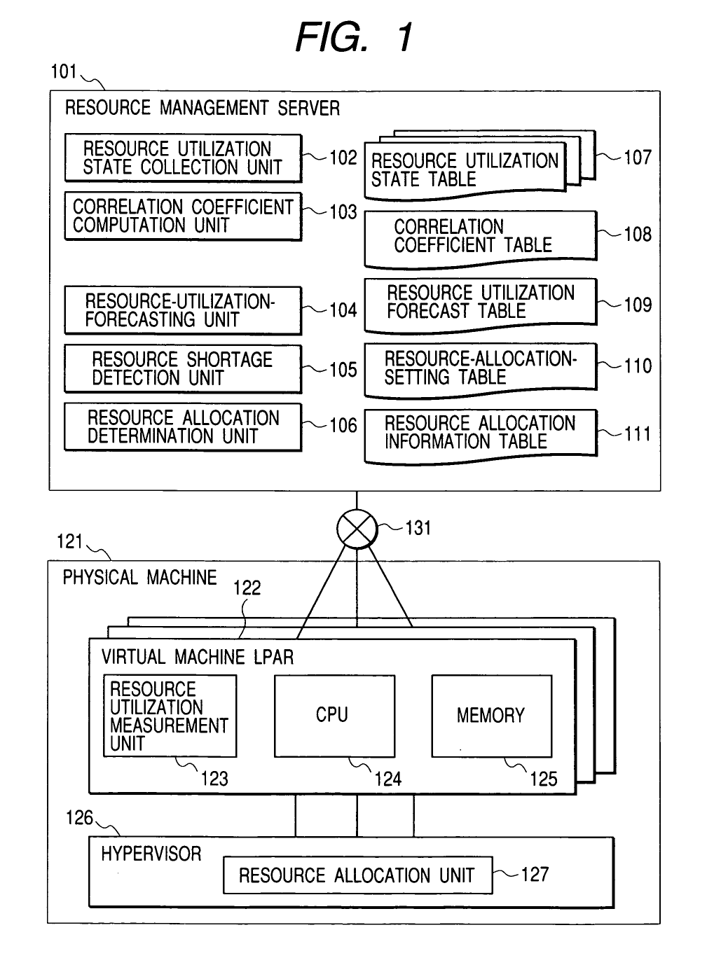

Embodiments of the present invention will be described referring to FIGS. 1 to 14 as follows.

[Configuration of the Virtual Machine System]

First of all, referring to FIG. 1, the following description explains the configuration of a virtual machine system adopting a method of allocating computer resources in accordance with the present invention. FIG. 1 is a diagram showing the configuration of a virtual machine system adopting the computer-resource allocation method provided by the present invention.

The virtual machines has a configuration comprising a physical machine 121 and a resource management server 101, which are connected to each other by a network 131. In this case, the physical machine 121 is a technical term used for distinguishing this term from the technical term ‘virtual machine’. To put it in detail, a virtual machine is logically constructed on hardware of the physical machine 121 as a logical computer seen by the user. To put it concretely, a plurality of virtual machine LPARs (Logical Partitions) 122 can be constructed on the physical machine 121.

The resource management server 101 is a server for managing computer resources to be allocated to the virtual machine LPARs 122 and issuing a command to allocate the computer resources properly. The resource management server 101 has functional modules and data tables. The functional modules include a resource utilization state collection unit 102, a correlation coefficient computation unit 103, a resource-utilization-forecasting unit 104, a resource shortage detection unit 105 and a resource allocation determination unit 106. The data tables include a resource utilization state table 107, a correlation coefficient table 108, a resource utilization forecast table 109, a resource-allocation-setting table 110 and a resource allocation information table 111.

As described above, a plurality of virtual machine LPARs 122 is constructed on the physical machine 121, and the virtual machine LPARs 122 are capable of operating independently of each other. In addition, a CPU and memory of the physical machine 121 are allocated to the virtual machine LPARs 122 in such a way that each of the virtual machine LPARs 122 appears as if each of the virtual machine LPARs 122 were provided with its own CPU 124 and memory 125. A virtual machine LPAR 122 further has a resource utilization measurement unit 123 for measuring data related to the utilization of computer resources in the virtual machine LPAR 122.

A hypervisor 126 is a control function for logically dividing the physical machine 121 in order to construct a plurality of virtual machine LPARs 122. The hypervisor 126 has a resource allocation unit 127 for allocating computer resources to the virtual machine LPARs 122.

The resource utilization measurement unit 123 of a virtual machine LPAR 122 periodically measures data related to the utilization of computer resources in the virtual machine LPAR 122. Examples of the data related to the utilization of computer resources in the virtual machine LPAR 122 are the activity ratio of the CPU 124 and the used area size of the memory 125. The resource utilization measurement unit 123 then transmits measured data related to the utilization of computer resources to the resource utilization state collection unit 102 employed in the resource management server 101. The resource utilization state collection unit 102 receives pieces of measured data related to the utilization of computer resources from the resource utilization measurement unit 123 and collects the data, storing the collected data in the resource utilization state table 107 and the resource allocation information table 111.

Then, the correlation coefficient computation unit 103 uses the resource utilization state table 107 to find coefficients of correlation among the virtual machine LPARs 122, and stores the coefficients in the correlation coefficient table 108. A coefficient of correlation is an index as to how a virtual machine LPAR 122 operates at a correlation with other virtual machine LPARs 122 with respect to the state of resource utilization. A coefficient of correlation will be described later.

Each time the resource utilization state collection unit 102 collects data, the resource-utilization-forecasting unit 104 uses the resource utilization state table 107 to forecast resource utilizations in an operating state for each virtual machine LPAR 122, and stores the forecasted states of resource utilization in the resource utilization forecast table 109.

Then, the resource shortage detection unit 105 forms a judgment as to whether or not the quantity or each computer resource allocated to every virtual machine LPAR 122 is sufficient on the basis of forecasted values of resource utilizations stores in the resource utilization forecast table 109. If the quantity of a computer resource allocated to a specific virtual machine LPAR 122 is found insufficient, the resource allocation determination unit 106 newly determines reapportioned quantities of the computer resource and stores information on the newly determined quantities of the computer resource in the resource allocation information table 111. The resource allocation determination unit 106 further transmits the information stored in resource allocation information table 111 to the resource allocation unit 127 employed in the hypervisor 126. The resource allocation unit 127 then changes the allocation quantities of the CPU 124 and memory 125 apportioned to the specific virtual machine LPAR 122 in accordance with the information on allocated resource quantities.

In this embodiment, only a CPU and a memory are taken as examples of computer resources. It is to be noted that there are also other computer resources. Examples of the other computer resources are I/O resources such as disks used in a virtual machine LPAR 122 and channels.

[Structures of Data Used in the Computer Resource Allocation Method]

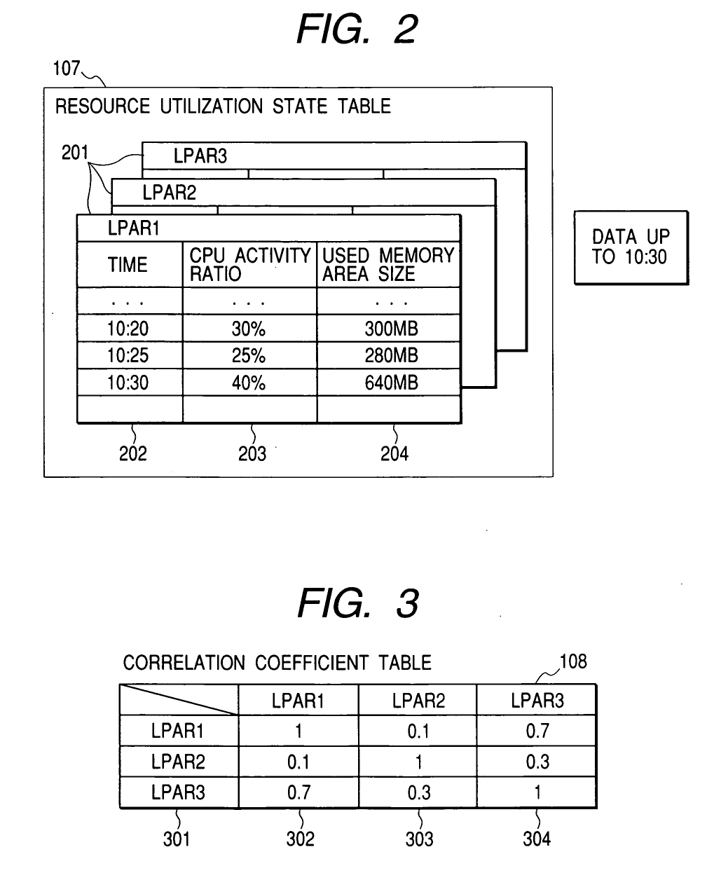

Referring to FIGS. 2 to 6, the following description explains structures of data used in the computer resource allocation method provided by the present invention.

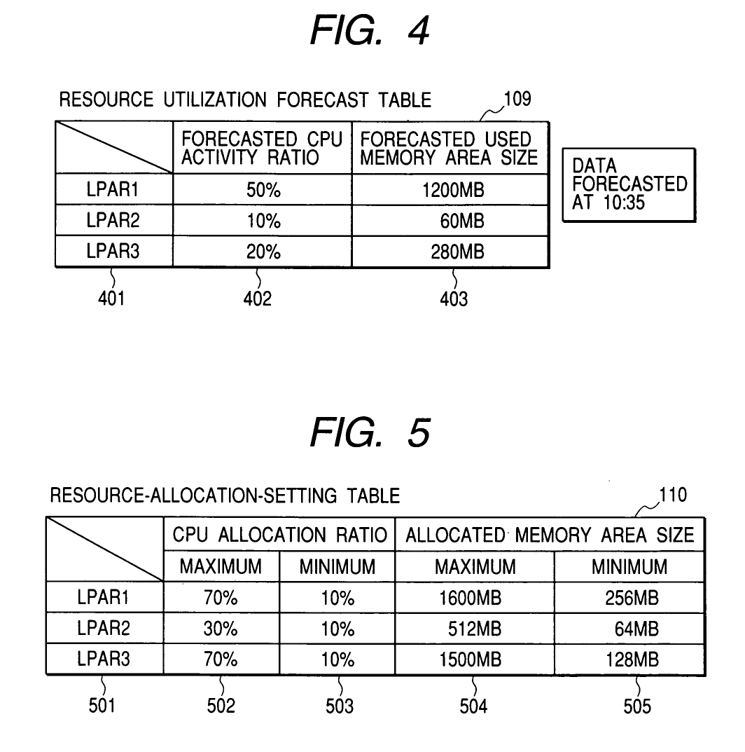

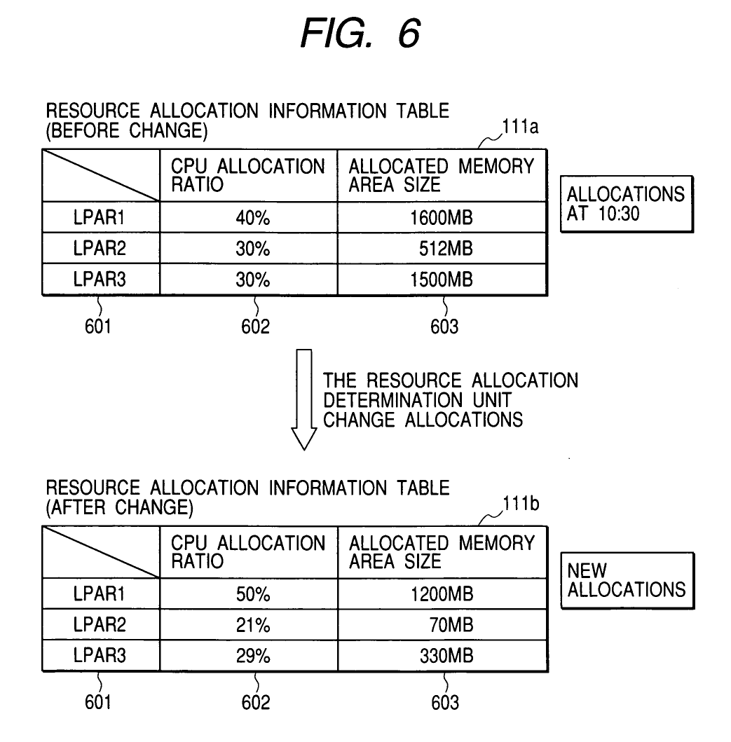

FIG. 2 is a diagram showing the structure of the resource utilization state table 107. FIG. 3 is a diagram showing the structure of the correlation coefficient table 108. FIG. 4 is a diagram showing the structure of the resource utilization forecast table 109. FIG. 5 is a diagram showing the structure of a resource-allocation-setting table 110. FIG. 6 is a diagram showing the structure of the resource allocation information table 111.

Provided for each virtual machine LPAR 122, the resource utilization state table 107 is a table for storing pieces of resource utilization data in a time-series basis. As shown in FIG. 2, reference numeral 201 denotes the number of a virtual machine LPAR 122 for which the resource utilization state table 107 is provided. Reference numerals 202, 203 and 204 denote respectively a time, a CPU activity ratio and a used memory area size in the time-series basis. Each time 202 is associated with a CPU activity ratio 203 and a used memory area size 204.

Expressed in terms of percents (%), a CPU activity ratio 203 of a virtual machine LPAR 122 represents a ratio of a time portion, during which the CPU 124 employed in the physical machine 121 has been actually used by the virtual machine LPAR 122 indicated by the LPAR number 201 at the time 202, to a predetermined time interval ending at the time 202. For example, a CPU activity ratio 203 of 40% at 10:30 shown in the figure indicates that, during a time interval of 5 minutes from 10:25 to 10:30, LPAR #1 has used the CPU 124 for 2 minutes (=40%×5 minutes). On the other hand, a used memory area size 204 of a virtual machine LPAR 122 is the size of an area included in the memory 125 to serve an area actually used by the virtual machine LPAR 122 indicated by the LPAR number 201.

As described above, the resource utilization state table 107 is used for storing data related to states of resource utilization in the form of a time-series. The data has been collected by the resource utilization state collection unit 102 from virtual machine LPARs 122. The data is used by the correlation coefficient computation unit 103 to compute coefficients of correlation and by the resource-utilization-forecasting unit 104 to forecast a state of resource utilization.

The correlation coefficient table 108 is a table for storing coefficients of correlation. A coefficient of correlation represents a correlation between virtual machine LPARs 122 with respect to a state of resource utilization. The coefficients of correlation have been found from actual states of resource utilizations for the virtual machine LPARs 122. As shown in FIG. 3, the correlation coefficient table 108 comprises an LPAR-number column 301 and correlation coefficient columns 302, 303 and 304 for all virtual machine LPARs 122. A virtual machine LPAR 122 indicated by a LPAR number 301 is associated with coefficients of correlation on the correlation coefficient columns 302, 303 and 304.

A coefficient of correlation represents a correlation between resource utilization states of any 2 virtual machine LPARs 122. Let kᵢⱼ denote a coefficient of correlation between resource utilization states of LPAR #i and LPAR #j. The value of kᵢⱼ satisfies the following conditions: 0≦kᵢⱼ≦1. The kᵢⱼ value of 0 indicates that there is no correlation between the resource utilization states of LPAR #i and LPAR #j. On the other hand, the kᵢⱼ value of 1 indicates that there is a tight correlation between performances of LPAR #i and LPAR #j. It is to be noted that a large kᵢⱼ value, that is, a kᵢⱼ value close to 1, indicates that as the quantities of computer resources allocated to LPAR #i increase, the quantities of the computer resources allocated to LPAR #j also increase or show a tendency to increase as well in a near future. On the other hand, a small kᵢⱼ value, that is, a kᵢⱼ value close to 0, indicates that changes in computer resources allocated to LPAR #i do not have any effects at all on computer resources allocated to LPAR #j or utilization states of computer resources allocated to LPAR #j decrease or increase independently of computer resources allocated to LPAR #i.

The correlation coefficient table 108 is used for storing correlation coefficients computed by the correlation coefficient computation unit 103 on the basis of the resource utilization state table 107. The coefficients of correlation are used by the resource allocation determination unit 106 to allocate computer resources to virtual machine LPARs 122.

The resource utilization forecast table 109 is a table for storing forecasted values of states of resource utilizations for each virtual machine LPAR 122. As shown in FIG. 4, a forecasted CPU activity ratio 402 and a forecasted used memory area size 403 are stored for each LPAR number 401 in the resource utilization forecast table 109, being associated with the LPAR number 401.

The resource utilization forecast table 109 is used for storing forecasted data computed by the resource-utilization-forecasting unit 104 on the basis of data stored in the resource utilization state table 107. For example, the resource utilization forecast table 109 is used for storing pieces of forecasted data, which have been computed at intervals of 5 minutes. Assume that data forecasted at 10:30 has been stored. In this case, the resource-utilization-forecasting unit 104 computes data forecasted at 10:35, which is taken as the next timing, and stores the computed data in the resource utilization forecast table 109.

The resource-allocation-setting table 110 is a table for storing ranges of resource allocations for each virtual machine LPAR 122. As shown in FIG. 5, a maximum value 502 and minimum value 503 of a CPU allocation ratio 402 as well as a maximum value 504 and minimum value 505 of an allocated memory area size 403 are stored for each LPAR number 501 in the resource-allocation-setting table 110, being associated with the LPAR number 501.

The maximum value 502 and minimum value 503 of each CPU activity ratio 402 as well as the maximum value 504 and minimum value 505 of each allocated memory area size, which are stored in advance in the resource-allocation-setting table 110 for allocating computer resources to virtual machine LPARs 122, are appropriately updated.

Expressed in terms of percents (%), a CPU allocation ratio of a virtual machine LPAR 122 is a ratio of a time portion, during which the CPU 124 employed in the physical machine 121 is allocated to the virtual machine LPAR 122, to a predetermined time interval. For example, a CPU allocation ratio of 10% indicates that, in a predetermined time interval of 5 minutes, the CPU 124 is allocated to the virtual machine LPAR 122 for 30 seconds (=10%×5 minutes×60 seconds per minute). A CPU allocation ratio of a virtual machine LPAR 122 is different from a CPU activity ratio of the virtual machine LPAR 122 for the same time interval. That is to say, the following relation between the CPU allocation ratio and the CPU activity ratio holds true: the CPU allocation ratio≧the CPU activity ratio. Take the CPU allocation ratio of 10% and the time interval of 5 minutes as an example. In this case, the CPU 124 is allocated to the virtual machine LPAR 122 for 30 seconds. However, the virtual machine LPAR 122 may occupy the CPU 124 for only 15 seconds, which are expressed by a CPU activity ratio of 5%. On the other hand, an allocated memory area size is the size of an area included in the memory 125 as an area allocated to the virtual machine LPAR 122. Similarly, an allocated memory area size of a virtual machine LPAR 122 is different from a used memory area size of the virtual machine LPAR 122 for the same time interval. That is to say, the following relation between the allocated memory area size and the used memory area size holds true: the allocated memory area size≧the used memory area size.

The resource allocation information table 111 is a table used for determining resource allocations to virtual machine LPARs 122. As shown in FIG. 6, for each LPAR number 601, a CPU allocation ratio 602 and an allocated memory area size 603 are stored, being associated with the LPAR number 601.

A resource allocation information table 111a prior to changes is used for storing information on states of resource utilization. The information has been collected by the resource utilization state collection unit 102 and will be used by the resource shortage detection unit 105 and the resource allocation determination unit 106 to determine allocation of computer resources.

The resource allocation determination unit 106 determines new information on states of resource utilization and stores the new information back in the resource allocation information table 111 to give a resource allocation information table 111b. The values stored in the resource allocation information table 111b are transmitted to the resource allocation unit 127 of the hypervisor 126.

[Processing to Implement the Computer-Resource Allocation Method]

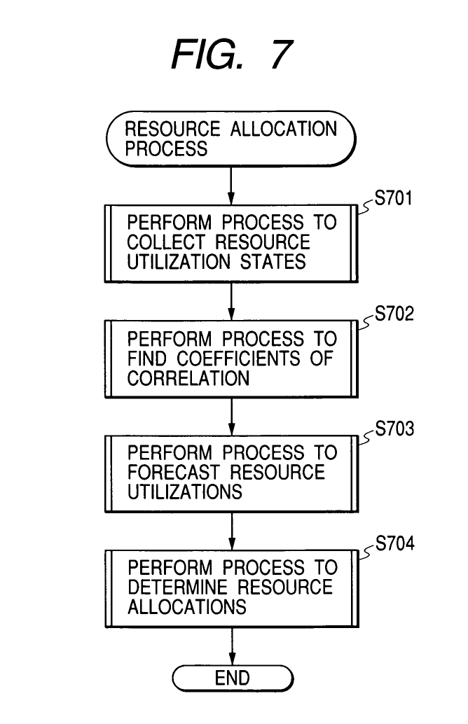

Referring to FIGS. 7 to 13, the following description explains processing carried out to implement a method to allocate computer resources in accordance with the present invention.

First of all, an outline of processing carried out to implement a method to allocate computer resources in accordance with the present invention is explained referring to FIG. 7. FIG. 7 shows a general flowchart showing execution of processes according to the computer-resource allocation method provided by the present invention.

The flowchart begins with a step S701 to perform a process to collect states of resource utilization. In this process, the resource utilization state collection unit 102 employed in the resource management server 101 collects states of resource utilization from virtual machine LPARs 122 and stores in the resource utilization state tables 107 each provided for one of the virtual machine LPARs 122.

Then, at the next step S702, by referring to the resource utilization state tables 107, the correlation coefficient computation unit 103 employed in the resource management server 101 finds coefficients of correlation representing correlations among the virtual machine LPARs 122 and stores the coefficients of correlation in the correlation coefficient table 108.

Subsequently, at the next step S703, by referring to the resource utilization state tables 107, the resource-utilization-forecasting unit 104 employed in the resource management server 101 forecasts resource utilization states of the virtual machine LPARs 122 and stores the forecasted data in the resource utilization forecast table 109.

Then, at the next step S704, the resource allocation determination unit 106 employed in the resource management server 101 determines a virtual machine LPAR 122 whose states of resource utilization are to be changed. Then, the resource allocation determination unit 106 finds new allocated resource quantities and stores the quantities in the resource allocation information table 111. The resource allocation determination unit 106 also transmits the quantities to the hypervisor 126.

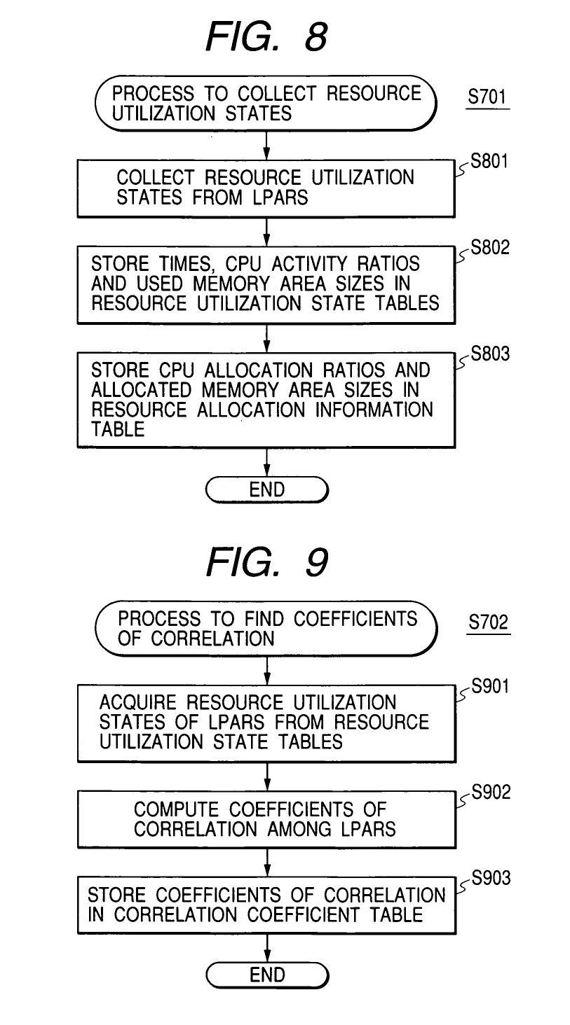

Details of each process shown in FIG. 7 are explained as follows. First of all, the process carried out at the step S701 to collect states of resource utilization is explained referring to FIG. 8.

A flowchart shown in FIG. 8 begins with a step S801 at which the resource utilization state collection unit 102 collects data 001 representing states of resource utilization like those shown in Table 1 given below from virtual machine LPARs 122.

TABLE 1
Data representing states of resource utilization collected from LPARs

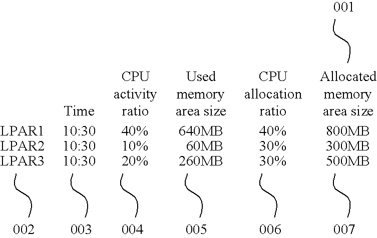

Then, at the next step S802, times 003, CPU activity ratios 004 and used memory sizes 005 are fetched from the data 001 and stored in the corresponding resource utilization state tables 107 as times 202, CPU activity ratios 203 and used memory sizes 204 respectively.

Subsequently, at the next step S803, CPU allocation ratios 006 and allocated memory sizes 007 are fetched from the data 001 and stored in the resource allocation information table 111 as CPU allocation ratios 602 and allocated memory sizes 603 respectively.

Referring to FIG. 9, the following description explains the process carried out at the step S702 to compute coefficients of correlation.

First of all, at a step S901, the correlation coefficient computation unit 103 acquires data representing states of resource utilization for virtual machine LPARs 122 from resource utilization state tables 107. Then, at the next step S902, the correlation coefficient computation unit 103 computes coefficients of correlation among the virtual machine LPARs 122.

As shown in the correlation coefficient table 108 of FIG. 3, the correlation coefficient computation unit 103 computes coefficients of correlation for all combinations of the virtual machine LPARs 122. Assume for example that there are n LPARs. In this case, the correlation coefficient computation unit 103 computes coefficients of correlation for n×n combinations of the virtual machine LPARs 122. CPU activity ratios 203 or used memory sizes 204 for times on the time column 202 are fetched from a resource utilization state table 107 and expressed by a vector pᵢ (=pᵢ₁, pᵢ₂, - - - , pᵢₜ). A coefficient of correlation between LPARi and LPARj is expressed in terms of a vector inner product and vector lengths by Eq. (1) as follows.

$${K}_{ij} = \frac{( {p}_{i} \cdot {p}_{j} )}{\vert {p}_{i} \vert \cdot \vert {p}_{j} \vert} = \frac{{\sum }_{t} {p}_{it} \cdot {p}_{jt}}{\sqrt{{\sum }_{t} {p}_{it}^{2}} \sqrt{{\sum }_{t} {p}_{jt}^{2}}} \qquad ( 1 )$$

As described above, a coefficient of correlation can be computed for CPU activity ratios and another coefficient of correlation can be computed for used memory sizes. Then, at the next step S903, the computed coefficients of correlation are stored in the correlation coefficient table 108. Thus, coefficients of correlation are stored in the correlation coefficient table 108 as coefficients of correlation computed for CPU activity ratios and coefficients of correlation computed for used memory sizes. As an alternative, the coefficients of correlation stored in the correlation coefficient table 108 are only the coefficients of correlation computed for CPU activity ratios or only the coefficients of correlation computed for used memory sizes. As another alternative, the coefficients of correlation stored in the correlation coefficient table 108 are average values of the coefficients of correlation computed for CPU activity ratios and the coefficients of correlation computed for used memory sizes.

The characteristic of a program running on each virtual machine LPAR greatly changes from time frame to time frame. This is because, in a time frame, a program may be executed in an online operation while, in another time frame, another program may be executed in a batch operation. For this reason, the data representing states of resource utilization is divided into portions each corresponding to a time frame. From such a portion, coefficients of correlation optimum for a time frame corresponding to the portion can thus be computed. At the start of a new operation, the data representing states of resource utilization may be unavailable yet. Thus, coefficients of correlation for a virtual machine LPAR 122 for carrying out the new operation may be computed by using another means or merely obtained as estimated values and stored in the correlation coefficient table 108.

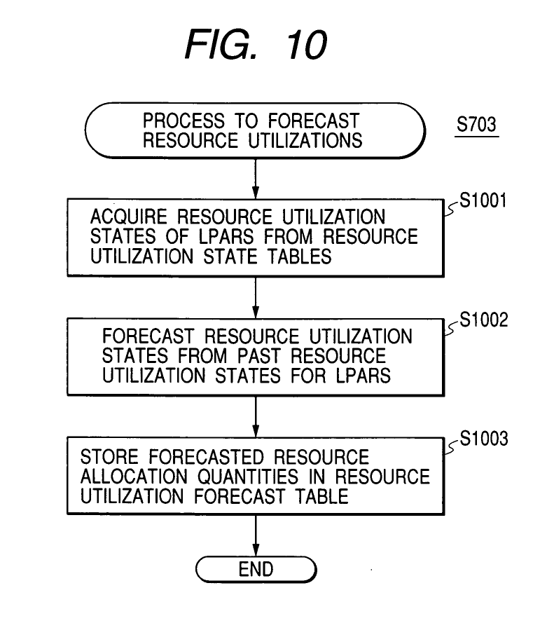

Referring to FIG. 10, the following description explains the process carried out at the step S703 to forecast resource utilizations.

A flowchart shown in the figure begins with a step S1001 to acquire CPU activity ratios 203 and used memory sizes 204 of virtual machine LPARs 122 for times 202 from resource utilization state tables 107. Then, at the next step S1002, future states of resource utilization are forecasted for each virtual machine LPAR on the basis of the acquired data representing past states of resource utilization. Future states of resource utilization are forecasted by typically adoption of a technique using an (m−1)th order function connecting m points representing data of the most recent past states of resource utilization by a smooth curve or a straight line. Then, a point on the curve or the straight line is determined as a point of time corresponding to a timing to receive next data representing a future state of resource utilization. From the determined point on the curve or the straight line, it is possible to derive the data representing a future state of resource utilization.

The forecasted future states of resource utilization are a CPU activity ratio and a used memory size.

Then, at the next step S1003, the forecasted future states of resource utilization computed for each virtual machine LPAR are stored as a CPU activity ratio 402 and a used memory size 403 in the resource utilization forecast table 109.

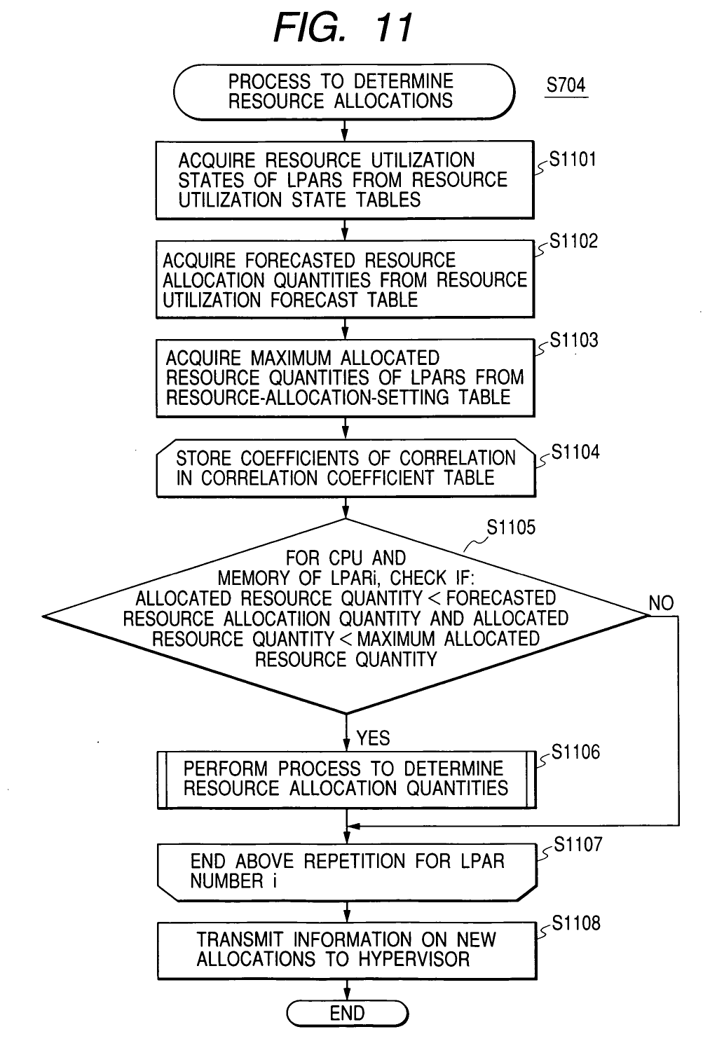

Referring to FIG. 11, the following description explains the process carried out at the step S704 to determine quantities of resource allocations.

The flowchart shown in the figure begins with a step S1101 to acquire CPU allocation ratio 602 and an allocated memory area size 603 for each virtual machine LPAR 122 from the resource allocation information table 111.

Then, the flow of the process goes on to the next step S1102 to acquire a CPU activity ratio 402 and a used memory size 403 for each virtual machine LPAR 122 from the resource utilization forecast table 109.

Then, the flow of the process goes on to the next step S1103 to acquire a maximum CPU allocation ratio 502 as well as a maximum allocated memory area size 504 from the resource-allocation-setting table 110.

Then, operations of the following steps S1105 to S1107 are carried out repeatedly for LPAR numbers i=1, 2 and 3.

If a CPU activity ratio and/or memory size allocated to LPARi are not sufficient and the allocated CPU activity ratio and/or the allocated memory size can still be increased, the allocated CPU activity ratio and/or the allocated memory size are increased. To put it concretely, at the step S1105, the allocated resource quantity is compared with the forecasted resource allocation quantity and the maximum allocated resource quantity. If the allocated resource quantity is found smaller than the forecasted resource allocation quantity as well as smaller than the maximum allocated resource quantity, the flow of the process goes on to a step S1106 at which new allocated resource quantities are determined. The process to determine new allocated resource quantities is implemented by a subroutine, which will be explained later in detail. If the allocated resource quantity is not smaller than the forecasted resource allocation quantity or not smaller than the maximum allocated resource quantity, on the other hand, the flow of the process goes on to the step S1107 to form a judgment as to whether or not the operations of the following steps S1105 and S1106 have been carried out for all LPAR numbers i=1, 2 and 3. If the operations of the following steps S1105 and S1106 have not been carried out for all LPAR numbers i=1, 2 and 3, the flow of the process goes back to the step S1105.

If the outcome of the judgment formed at the step S1107 indicates that the operations of the following steps S1105 and S1106 have been carried out for all LPAR numbers i=1, 2 and 3, on the other hand, the flow of the process goes on to a step S1108.

Finally, at the last step S1108, the data stored in the resource allocation information table 111 is transmitted to the resource allocation unit 127 employed in the hypervisor 126 by way of the network 131.

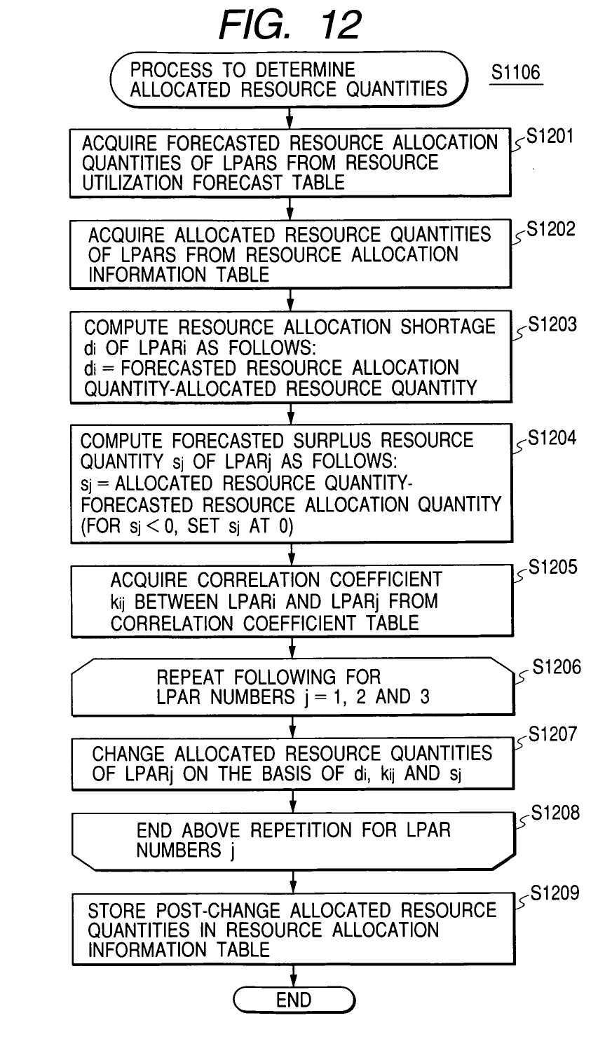

Referring to FIG. 12, the following description explains the process carried out at the step S1106 to determine new allocated resource quantities.

A subroutine representing this process is called at the step S1106 of the flowchart shown in FIG. 11 when the quantity of a computer resource allocated to virtual machine logical partition LPARi is found insufficient. In this process, the quantity of the computer resource allocated to each other virtual machine LPAR 122 is reduced and the decrease in allocated-resource quantity is transferred to virtual machine logical partition LPARi. The other virtual machine LPARs 122 are referred to hereafter as LPARj where j=1, 2 and 3. That is to say, the quantity of the resource allocated to virtual machine logical partition LPARi with an insufficient quantity apportioned thereto is newly determined in accordance with the coefficients of correlation between virtual machine logical partition LPARi and the other virtual machine LPARs 122.

First of all, at a step S1201, forecasted resource allocation quantities of each virtual machine LPAR 122 are obtained from the resource utilization forecast table 109. A forecasted resource allocation quantity can be a CPU activity ratio 402, a used memory size 403 or both. In this case, forecasted resource allocation quantities acquired from the resource utilization forecast table 109 are allocated resource quantities determined by the judgment formed at the step S1105 to be insufficient allocated resource quantities.

Then, at the next step S1202, allocated resource quantities of each virtual machine LPAR 122 are obtained from the resource allocation information table 111. An allocated resource quantity can be a CPU allocation ratio 602, an allocated memory area size 603 or both. In this case, the allocated resource quantities acquired from the resource allocation information table 111 are allocated resource quantities determined by the judgment formed at the step S1105 to be insufficient allocated resource quantities.

Subsequently, at the next step S1203, a forecasted resource allocation shortage dᵢ=the forecasted resource allocation quantity−the allocated resource quantity of virtual machine logical partition LPARi is computed.

Then, at the next step S1204, a forecasted surplus resource quantity sⱼ=the allocated resource quantity−the forecasted resource allocation quantity of LPARj, where j=1, 2 and 3, is computed. For sⱼ<0, sⱼ is set at 0.

Subsequently, at the next step S1205, coefficients of correlation kᵢⱼ between virtual machine logical partition LPARi and LPARj, where j=1, 2 and 3, are acquired from the correlation coefficient table 108.

Operations of steps S1206 to S1208 are repeated for LPARj, where j=1, 2 and 3. To be more specific, at a step S1207, allocated resource quantities of LPARj, where j=1, 2 and 3, are changed on the basis of the forecasted resource allocation shortage di and the forecasted surplus resource quantity sⱼ, where j=1, 2 and 3, which have been computed above, and on the basis of the acquired coefficients of correlation kᵢⱼ. A change Δⱼ in quantity apportioned to LPARj, where j=1, 2 and 3, is computed in accordance with Eq. (2) below. This change Δⱼ is to be additionally allocated to virtual machine logical partition LPARi.

$${Δ}_{j} = \frac{{d}_{i} \cdot {S}_{j} \cdot ( 1 - {K}_{ij} )}{{\sum }_{l} {S}_{l} \cdot ( 1 - {K}_{il} )} \qquad ( 2 )$$

The change Δⱼ is a quantity of a computer resource to be transferred from LPARj, where j=1, 2 and 3, to virtual machine logical partition LPARi to compensate virtual machine logical partition LPARi for the forecasted resource allocation shortage dᵢ. The change Δⱼ is computed in accordance with the forecasted surplus resource quantity sⱼ and the acquired coefficients of correlation kᵢⱼ. In accordance with Eq. (2), the change Δⱼ is actually computed in accordance with the forecasted surplus resource quantity sⱼ and a degree of uncorrelatedness expressed by a term (1−kᵢⱼ). Then, if a sum of the changes Δⱼ is found for all LPAR numbers j, the sum should be equal to the forecasted resource allocation shortage di of virtual machine logical partition LPARi. The process to find changes Δⱼ will be exemplified later concretely.

If a change Δⱼ is found greater than the forecasted surplus resource quantity sⱼ, the change Δⱼ is set at the forecasted surplus resource quantity sⱼ (Δⱼ=sⱼ). The technique to find a change Δⱼ is not limited to Eq. (2). Another method based on the coefficient of correlation kᵢⱼ can also be adopted. Finally, at the last step S1209, quantities obtained as results of subtracting computed changes Δⱼ from allocated resource quantities are stored in the resource allocation information table 111 as a new CPU allocation ratio 602 and/or a new allocated memory area size 603.

By using numbers shown in FIGS. 3, 4 and 6, the following description explains an example of a process to indicate that the CPU resource quantity apportioned to the virtual machine logical partition LPAR1 is insufficient, and CPU resource quantities apportioned to other virtual machine LPARs 122 are decreased to compensate the virtual machine logical partition LPAR1 for the allocated quantity shortage.

By subtracting an allocated CPU resource quantity 602 of 40% from a forecasted CPU resource allocation quantity 402 of 50%, a forecasted CPU resource allocation shortage d₁ of virtual machine logical partition LPAR1 is found to be 10%. A forecasted surplus CPU resource quantity sⱼ of each LPARj, where j=1, 2 and 3, is found as follows: S₁=0%, S₂=30%−10%=20% and S₃=30%−20%=10%. Thus, changes Δⱼ to be subtracted from the CPU resource quantities apportioned to LPARj where j=1 to 3 are a change Δ₁ of 0%, a change Δ₂ of 8.57%≈9% and a change Δ₃ of 1.43%≈1%. That is to say, a change Δ₂ of 9% is subtracted from the CPU resource quantity apportioned to virtual machine logical partition LPAR2 and transferred to the CPU resource quantity apportioned to virtual machine logical partition LPAR1 whereas a change Δ₃ of 1% is subtracted from the CPU resource quantity apportioned to virtual machine logical partition LPAR3 and transferred to the CPU resource quantity apportioned to virtual machine logical partition LPAR1. As a result, a change (Δ₂+Δ₃) of 10% is added to the CPU resource quantity apportioned to virtual machine logical partition LPAR1.

By reallocating the changes Δ₂ and Δ₃ in allocated CPU resource to virtual machine logical partition LPAR1, the resulting new CPU allocation ratios are a CPU allocation ratio of 50% (=40%+Δ₂+Δ₃) for virtual machine logical partition LPAR1, a CPU allocation ratio of 21% (=30%−Δ₂) for virtual machine logical partition LPAR2 and a CPU allocation ratio of 29% (=30%−Δ₃) for virtual machine logical partition LPAR3.

In the above example, the coefficient of correlation between virtual machine logical partition LPAR1 and virtual machine logical partition LPAR 3 is a large number of 0.7 close to 1. Thus, when the CPU resource quantity apportioned to virtual machine logical partition LPAR1 becomes insufficient, the CPU resource quantity apportioned to virtual machine logical partition LPAR3 shows a tendency to become insufficient as well in the near future. The use of this large coefficient of correlation in the computation of a change in allocated CPU resource quantity results in a small change Δ₃ (=1%) in CPU resource quantity apportioned to virtual machine logical partition LPAR3. As a result, the CPU resource quantity apportioned to the virtual machine logical partition LPAR3 is not much reduced. On the other hand, the coefficient of correlation between virtual machine logical partition LPAR1 and virtual machine logical partition LPAR2 is a small number of 0.1 close to 0. Thus, when the CPU resource quantity apportioned to virtual machine logical partition LPAR1 becomes insufficient, the CPU resource quantity apportioned to virtual machine logical partition LPAR2 does not likely become insufficient as well in the near future. The use of this small coefficient of correlation in the computation of a change in allocated CPU resource quantity results in a large change Δ₂ (=9%) in CPU resource quantity apportioned to virtual machine logical partition LPAR2. As a result, the CPU resource quantity apportioned to virtual machine logical partition LPAR2 is much reduced.

The embodiment described above adopts a method for adjusting resource quantities apportioned to virtual machine LPARs 122 whereby, in order to adjust allocated resource quantities, forecasted resource allocation quantities are found from data of resource utilization states and used as new allocated resource quantities. It is to be noted, however, that resource quantities apportioned to virtual machine LPARs 122 can be adjusted directly referring to data stored in the resource utilization state tables 107 shown in FIG. 2 without finding forecasted resource allocation quantities to find new allocated resource quantities to be used for allocation of resources.

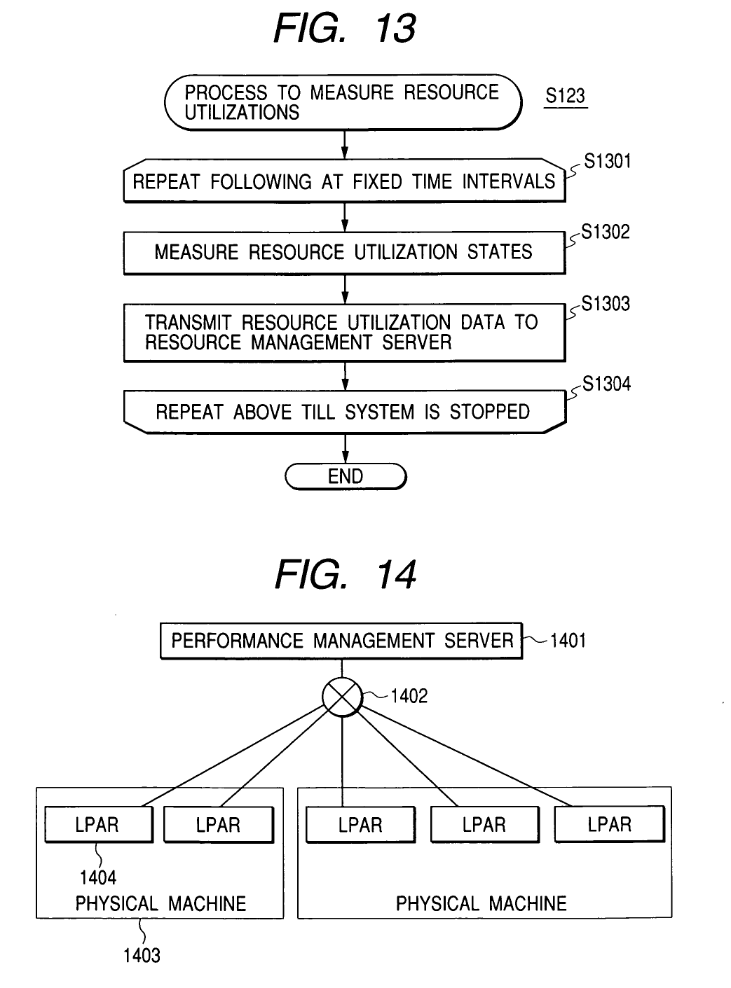

Next, a process to measure resource utilizations is explained referring to FIG. 13.

The process to measure resource utilizations is carried out by the resource utilization measurement unit 123 employed in each virtual machine LPAR 122 at fixed intervals until the system is stopped. To be more specific, operations of steps S1301 to S1304 of a flowchart shown in the figure are carried out repeatedly at fixed intervals till the system is halted.

The flowchart begins with a step S1302 to measure activity and allocation ratios of the CPU 124 and used-area and allocates-area sizes of the memory 125.

Then, at the next step S1303, the activity and allocation ratios of the CPU 124 and the used-area and allocates-area sizes of the memory 125, which are measured for each virtual machine LPAR 122, and their measurement time are transmitted as resource utilization data 001 with a format shown in Table 1 to the resource utilization state collection unit 102 employed in the resource management server 101. Receiving the resource utilization data 001, the resource utilization state collection unit 102 starts the process of the computer resource allocation method represented by the flowchart shown in FIG. 7.

Other Embodiment

The following description explains another embodiment of the virtual machine system adopting the method of allocating computer resources in accordance with the present invention.

FIG. 14 is a diagram showing the configuration of another virtual machine system adopting the method of allocating computer resources in accordance with the present invention.

In this embodiment, each physical machine 1403 includes a plurality of virtual machine LPARs 1404 as is the case with the first embodiment. A resource management server 1401 is connected to the virtual machine LPARs 1404 by a network 1402. The resource management server 1401 executes management of computer resources such as a CPU and a memory by issuing commands specifying quantities of computer resources to be allocated to the virtual machine LPARs 1404.

This embodiment is different from the first embodiment in that, in the case of this embodiment, there is a plurality of physical machines 1403 each having computer resources to be allocated to virtual machine LPARs 1404. In addition, computer resources pertaining to different physical machines 1403 may be allocated to a virtual machine LPAR 1404 and the quantities of computer resources included in different physical machines 1403 as computer resources allocated to a virtual machine LPAR 1404 can be adjusted.

That is to say, even if a virtual machine LPAR 1404 comprises computer resources of different physical machine, by adopting exactly the same method provided for the virtual machine system shown in FIG. 1, a CPU allocation ratio and allocated memory area size of each virtual machine LPAR can be adjusted in a reallocation process without increasing and decreasing a total performance of the physical machines. It is thus possible to operate a computer system in which quantities of computer resources allocated from physical machines can be changed as long as a total quantity of a computer resource allocated from any physical machine does not exceed a limit set for the physical machine where the quantity of a computer resource allocated from a physical machine can be a CPU allocation ratio or an allocated memory area size. By applying the present invention to such a computer system, the quantities of computer resources allocated from the physical machines can each be increased or decreased to as to allow computer resources to be allocated effectively to virtual machine LPARs 1404.

Applications of Embodiments

In a computer system for carrying out different jobs by using a web server, a database server and a development-use test server, which are each connected to the Internet as a server implemented by a virtual machine LPAR, assume that coefficients of correlation among the web server, the database server and the development-use test server represent observed phenomena wherein, when a load borne by the web server increases, a load borne by the database server will also rise in the near future, but a load borne by the development-use test server decreases and increases without regard to whether the load borne by the web server decreases or increases.

In this case, at a point of time a shortage of an allocated resource in the web server due to an increase in web-server load is forecasted, the CPU allocation ratio and allocated memory area size of the development-use test server having a small coefficient of correlation with the web server are much reduced. In this way, it is possible to prevent quantities of computer resources allocated to the web server, the database server and the development-use test server each serving as a virtual machine LPAR from being changed again due to the fact that the load borne by the database server having a large coefficient of correlation with the web server also rises in the near future to accompany the increase in web-server load.

In the embodiments described above, a resource management server allocates computer resources of a physical machine to a plurality of virtual machine LPARs. However, the present invention can also be applied to a computer system in which it is the physical machine itself that allocates computer resources of the physical machine to a plurality of virtual machine LPARs. In this computer system, the resource management server is not used. It is thus possible to construct such a computer system in which, at a request made by the physical machine, the CPU and memory of the physical machine are allocated to the virtual machine LPARs by adoption of the resource allocation method according to the present invention in such a way that the resource allocation quantities are optimized in accordance with coefficients of correlation among the virtual machine LPARs to result in an ideal distribution of computer resources.

In accordance with a policy provided by the present invention to dynamically reallocate a computer resource to a plurality of virtual machines, optimum quantities of resource allocation to the virtual machines are determined on the basis of coefficients of correlation among the virtual machines and the optimum quantities of the computer resource are apportioned to the virtual machines so that the virtual machines will hardly have resource shortages in the near future.

What is claimed is:

1. A computer-resource allocation method adopted by a computer system allocating a computer resource to a plurality of computers executing programs independently of each other, said method comprising the steps of:
(1) collecting states of computer-resource utilizations of said computers;
(2) computing coefficients of correlation among said computers with respect to said computer-resource utilizations of said computers on the basis of data representing said collected states of computer-resource utilizations; and
(3) computing computer-resource allocation quantities of said computers on the basis of said collected states of computer-resource utilizations and said computed coefficients of correlation and allocating said computer resource to said computers in accordance with said computer-resource allocation quantities.

2. A computer-resource allocation method according to claim 1 wherein said step (3) includes the sub-steps of:
forecasting states of computer-resource utilizations of said computers on the basis of data representing said collected states of computer-resource utilizations; and
allocating said computer resource to said computers in accordance with said forecasted states of computer-resource utilizations and said computed coefficients of correlation.

3. A computer-resource allocation method according to claim 1 wherein said step (3) includes the sub-steps of:
determining one of said computers as a specific computer requiring a larger allocated quantity of said computer resource;
setting a decrease in quantity for each of said computers at such a value that, the smaller the coefficient of correlation with said specific computer, the larger the value;
subtracting said decrease in quantity from a quantity of said computer resource allocated to each of said computers except said specific computer; and
transferring said decrease in quantity subtracted from said quantity of said computer resource allocated to each of said computers to said specific computer.

4. A computer-resource allocation method according to claim 1 wherein said coefficients of correlation are switched from one values to others in dependence on a time frame and characteristics of programs running on said computers.

5. A computer-resource management server for managing allocation of a computer resource in a computer system allocating said computer resource to a plurality of computers executing programs independently of each other, said computer-resource management server comprising:
a resource utilization state data collection unit for collecting states of computer-resource utilizations of said computers;
a correlation-coefficient computation unit for computing coefficients of correlation among said computers with respect to said computer-resource utilizations of said computers on the basis of data representing said collected states of computer-resource utilizations; and
a resource allocation unit for computing computer-resource allocation quantities of said computers on the basis of said collected states of computer-resource utilizations and said computed coefficients of correlation and allocating said computer resource to said computers in accordance with said computer-resource allocation quantities.

6. A computer-resource management server according to claim 5, said computer-resource management server further having a computer-resource-utilization-forecasting unit for forecasting states of computer-resource utilizations of said computers on the basis of data representing said collected states of computer-resource utilizations, wherein said resource allocation unit allocates said computer resource to said computers in accordance with said forecasted states of computer-resource utilizations.

7. A computer-resource management server according to claim 5, wherein said resource allocation unit:
determines one of said computers as a specific computer requiring a larger allocated quantity of said computer resource;
sets a decrease in quantity for each of said computers at such a value that, the smaller the coefficient of correlation with said specific computer, the larger the value;
subtracts said decrease in quantity from a quantity of said computer resource allocated to each of said computers except said specific computer; and
transfers said decrease in quantity subtracted from said quantity of said computer resource allocated to each of said computers to said specific computer.

8. A computer-resource management server according to claim 5 wherein said coefficients of correlation are switched from one values to others in dependence on a time frame and characteristics of programs running on said computers.

9. A computer system allocating a computer resource to a plurality of computers executing programs independently of each other, said computer system comprising:
a computer-resource management server for collecting states of computer-resource utilizations of said computers, for computing coefficients of correlation among said computers with respect to said computer-resource utilizations of said computers on the basis of data representing said collected states of computer-resource utilizations, computing computer-resource allocation quantities of said computers on the basis of said collected states of computer-resource utilizations and said computed coefficients of correlation, and transmitting said computer-resource allocation quantities; and
a control means for allocating said computer resource to said computers in accordance with said computer-resource allocation quantities received from said computer-resource management server.

10. A computer system according to claim 9 wherein, if a specific one of said computers is determined to be a computer, to which a larger quantity of said computer resource needs to be apportioned,
a decrease in quantity is set for each of said computers at such a value that, the smaller the coefficient of correlation with said specific computer, the larger the value or, the larger the coefficient of correlation with said specific computer, the smaller the value;
said decrease in quantity is subtracted from a quantity of said computer resource allocated to each of said computers except said specific computer; and
said decrease in quantity subtracted from said quantity of said computer resource allocated to each of said computers is transferred to said specific computer.

11. A computer system according to claim 9 wherein said computer resource allocated said computers is resources pertaining to a plurality of physical computers.
